(19) United States
(12) Patent Application Publication
(10) Pub. No.: US 2026/0082232 A1
(43) Pub. Date: Mar. 19, 2026

(54) CONTENT SERVICE AUTHORIZATION USING A WIRELESS USER EQUIPMENT (UE)

(71) Applicant: T-MOBILE INNOVATIONS LLC, Overland Park, KS (US)

(72) Inventors: Anuj Sharma, Broadlands, VA (US); Deepesh Belwal, Ashburn, VA (US)

(21) Appl. No.: 18/781,671

(22) Filed: Jul. 23, 2024

(51) Int. Cl. H04W 12/63; H04W 8/08; H04W 12/08; H04W 12/72

(52) U.S. Cl. CPC H04W 12/63; H04W 8/08; H04W 12/08; H04W 12/72

(57) ABSTRACT

A data communication system stores a User Equipment (UE) Identifier (ID) for a wireless UE in association with a geographic area for the wireless UE. The data communication system wirelessly transfers a wireless access node ID from a wireless access node in the geographic area to the wireless UE. The data communication system receives the UE ID and the wireless access node ID transferred by the wireless UE. The data communication system authorizes the wireless UE for a content service by associating the UE ID with the wireless access node ID based on the geographic area. The content service is delivered to the wireless UE in response to the authorization.

### TECHNICAL BACKGROUND

Wireless communication networks provide wireless content services to wireless communication devices like phones, computers, and other user devices. The wireless content services may include internet-access, data messaging, video conferencing, or some other data communication product. The wireless communication networks comprise wireless access nodes like Wireless Fidelity (WIFI) hotspots, Fifth Generation New Radio (5GNR) cell towers, and satellites in earth orbit. The wireless communication networks further comprise network elements the process network signaling and handle user data like Access and Mobility Management Functions, Session Management Functions (SMFs), User Plane Functions (UPFs), and Unified Data Management (UDMs).

Content providers deliver services like video/audio streaming, broadband internet access, interactive gaming, social networking, virtual/augmented reality, and artificial intelligence computing. The content providers authorize their users before delivering their services. The authorization often entails the collection and verification of a username and password. Unfortunately, the username and password can be improperly used by others to access the content service.

### TECHNICAL OVERVIEW

In some examples, a User Equipment (UE) Identifier (ID) is stored for a wireless UE in association with a geographic area for the wireless UE. A wireless access node ID is wirelessly transferred to the wireless UE from a wireless access node in the geographic area.

The UE ID and the wireless access node ID is transferred by the wireless UE and received. The wireless UE is authorized for a content service by associating the UE ID with the wireless access node ID based on the geographic area. The content service is delivered to the wireless UE in response to the authorization.

In some examples, one or more non-transitory computer readable storage media store program instructions. When executed by a computing system, the program instructions direct the computing system to perform the following operations. Store an International Mobile Subscriber Identifier (IMSI) for a user in association with a cell coverage area for the user. Receive the IMSI and a cell Identifier (ID) from the user wherein a wireless access node in the cell coverage area wirelessly transfers the cell ID to the user. Authorize the user for a content service by correlating the IMSI with the cell ID based on the cell coverage area for the user. Transfer an authorization for a content service for the user, where the content service is delivered to the UE in response to receiving the authorization.

In some examples, a control system stores a User Equipment (UE) Identifier (ID) for a wireless UE in association with a geographic area for the wireless UE. A wireless access node in the geographic area wirelessly transfers a wireless access node ID to the wireless UE. The control system receives the UE ID and the wireless access node ID transferred by the wireless UE. The control system authorizes the wireless UE for a content service by associating the UE ID with the wireless access node ID based on the geographic area. The content service is delivered to the wireless UE in response to the authorization.

### DESCRIPTION OF THE DRAWINGS

FIG. 1 illustrates an exemplary data communication system to authorize a wireless User Equipment (UE) for a content service.

FIG. 2 illustrates an exemplary operation of the data communication system to authorize the wireless UE for the content service.

FIG. 3 illustrates an exemplary operation of the data communication system to authorize the wireless UE for the content service.

FIG. 4 illustrates exemplary processing circuitry to authorize a wireless UE for a content service.

FIG. 5 illustrates an exemplary wireless communication network that authorizes a wireless UE for a content service.

FIG. 6 illustrates an exemplary UE in the wireless communication network that authorizes the wireless UE for the content service.

FIG. 7 illustrates an exemplary Fifth Generation New Radio (5GNR) access node in the wireless communication network that authorizes the wireless UE for the content service.

FIG. 8 illustrates an exemplary Wireless Fidelity (WIFI) access node in the wireless communication network that authorizes the wireless UE for the content service.

FIG. 9 illustrates an exemplary satellite access node and ground station in the wireless communication network that authorizes the wireless UE for the content service.

FIG. 10 illustrates an exemplary Network Function Virtualization Infrastructure (NFVI) in the wireless communication network that authorizes the wireless UE for the content service.

FIG. 11 illustrates an exemplary operation of the wireless communication network that authorizes the wireless UE for the content service.

FIG. 12 illustrates an exemplary operation of the wireless communication network that authorizes the wireless UE for the content service.

### DETAILED DESCRIPTION

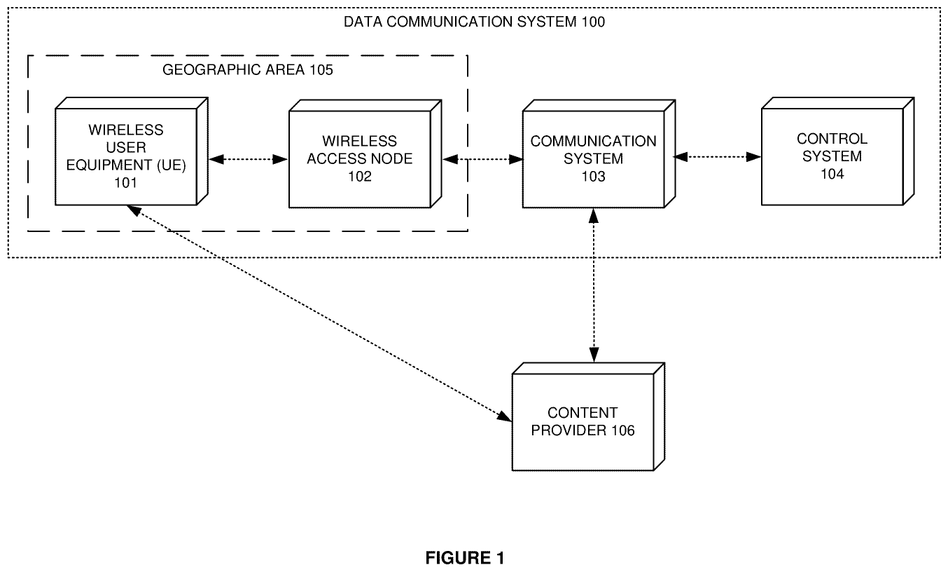

FIG. 1 illustrates exemplary data communication system 100 to authorize wireless UE 101 for a content service. The content service comprises video/audio streaming, broadband internet access, interactive gaming, social networking, virtual/augmented reality, artificial intelligence computing, or some user data product. Data communication system 100 comprises wireless User Equipment (UE) 101, wireless access node 102, communication system 103, and control system 104. Wireless UE 101 comprises a phone computer, vehicle, sensor, or some other user apparatus with wireless communication components. Wireless access node 102 comprises a Fifth Generation New Radio (5GNR) NodeB, satellite, wireless fidelity hotspot, or some other data equipment with wireless communication components. Communication system 103 comprises User Plane Functions (UPFs), Interworking Functions (IWFs), routers, gateways, or some other network elements. Control system 104 comprises Access and Mobility Management Functions (AMFs), Policy Control Functions (PCFs), Unified Data Repositories (UDRs), or some other network controllers. Geographic area 105 comprises a zip code, network cell or sector, physical address, or some other physically bounded area where a service is delivered. A network cell comprises a radio coverage area for wireless access node 102 and is typically circular. A network sector comprises a portion of the radio coverage area for wireless access node 102 and is typically pie-shaped. A physical address comprises the boundary of real property having a physical mailing address.

In some examples, communication system 103 stores a User Equipment (UE) Identifier (ID) for wireless UE 101 in association with geographic area 105 for wireless UE 101. The UE ID comprises an International Mobile Subscriber Identifier (IMSI), International Mobile Equipment Identifier (IMEI), telephone number, email address, Uniform Resource Identifier (URI), Mobile Station Integrated Services Digital Network (MSISDN), or some other user indicator. Wireless access node 102 in the geographic area 105 wirelessly transfers a wireless access node ID to wireless UE 101. Wireless UE 101 transfers a UE ID and the wireless access node ID to control system 104—possibly through content provider 106. The wireless access node ID comprises a 5GNR NodeB ID, satellite ID, wireless fidelity service set ID, or some other node indicator. Control system 104 receives the UE ID and the wireless access node ID transferred by wireless UE 101. Control system 104 authorizes wireless UE 101 for a content service by associating the UE ID with the wireless access node ID based on geographic area 105. For example, control system 105 may associate the UE ID with geographic area 105 based on storing the UE ID in association with geographic area 105. Control system 104 may then correlate geographic area 105 with the wireless access node ID based on a data structure that indicates the wireless access nodes that are located in geographic area 105. Content provider 106 delivers the content service to wireless UE 101 in response to the authorization.

In some examples, control system 104 stores the UE ID in association with a slice ID, Dynamic Network Name (DNN), Access Point Name (APN), or some other data system indicator. Control system 104 authorizes wireless UE 101 for the content service by associating the UE ID with the slice ID, DNN, APN, and/or other data system indicator. The slice ID, DNN, APN, or other data system indicator may comprise UE information that is assigned to UE 101 but that is not required. In some examples, geographic location 105 comprises a cell coverage area for wireless access node 102 that includes wireless UE 101. If the authorization fails, control system 104 may verify that the UE ID is on a list of authorized IDs that are not geographically restricted to authorize wireless UE 101.

In some examples, wireless access node 102 serves a cell coverage area and wirelessly broadcasts a corresponding cell ID throughout the cell coverage area Control system 104 comprises a computing system. One or more non-transitory computer readable storage media stores program instructions. When executed by the computing system, the program instructions direct the computing system to perform the following operations. Store an International Mobile Subscriber Identifier (IMSI) for a user of wireless UE 101 in association with the cell coverage area. Receive the IMSI and the cell ID from wireless UE 101. Authorize the user for a content service by correlating the IMSI with the cell ID based on the cell coverage area for the user. Transfer an authorization for the content service for the user to contentment provider 106, and in response, content provider 106 delivers the content service to wireless UE 101.

Wireless communication device 101 and wireless access node 102 may wirelessly communicate using wireless protocols like Wireless Fidelity (WIFI), Fifth Generation New Radio (5GNR), Long Term Evolution (LTE), Low-Power Wide Area Network (LP-WAN), Near-Field Communications (NFC), Code Division Multiple Access (CDMA), Frequency Division Multiple Access (FDMA), Time Division Multiple Access (TDMA), and satellite data communications. Wireless communication device 101, wireless access node 102, communication system 103, and control system 104 comprise microprocessors, software, memories, transceivers, bus circuitry, and/or some other data processing components. The microprocessors comprise Digital Signal Processors (DSP), Central Processing Units (CPU), Graphical Processing Units (GPU), Application-Specific Integrated Circuits (ASIC), and/or some other data processing hardware. The memories comprise Random Access Memory (RAM), flash circuitry, disk drives, and/or some other type of data storage. The memories store software like operating systems, utilities, protocols, applications, and functions. The microprocessors retrieve the software from the memories and execute the software to drive the operation of data communication system 100 as described herein.

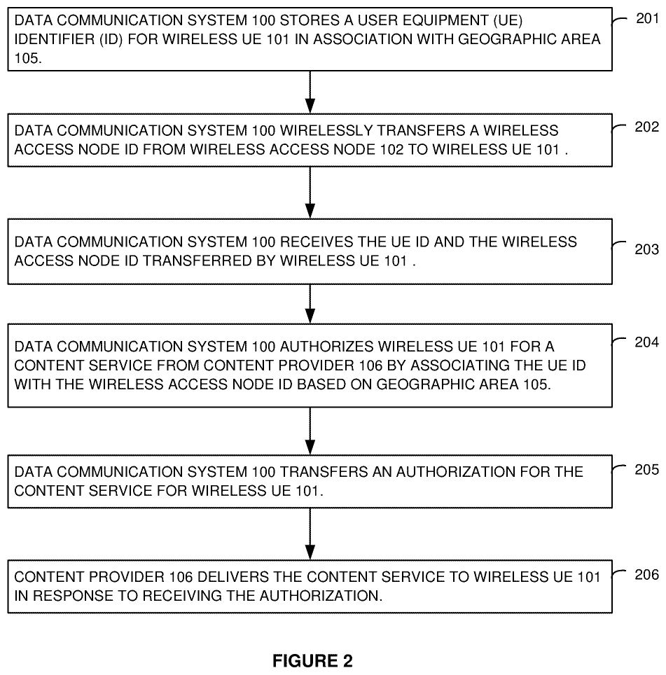

FIG. 2 illustrates an exemplary operation of data communication system 100 to authorize wireless UE 101 for the content service. The operation may differ in other examples. Data communication system 100 stores a User Equipment (UE) Identifier (ID) for wireless UE 101 in association with geographic area 105 for wireless UE 101 (201). Data communication system 100 wirelessly transfers a wireless access node ID to wireless UE 101 from wireless access node 102 in geographic area 105 (202). Data communication system 100 receives the UE ID and the wireless access node ID transferred by wireless UE 101 (203). Data communication system 100 authorizes wireless UE 101 for a content service by associating the UE ID with the wireless access node ID based on geographic area 105 (204). Data communication system 100 transfers an authorization for the content service from content provider 106 to wireless UE 101 (205). Content provider 106 delivers the content service wireless UE 101 in response to the authorization (206).

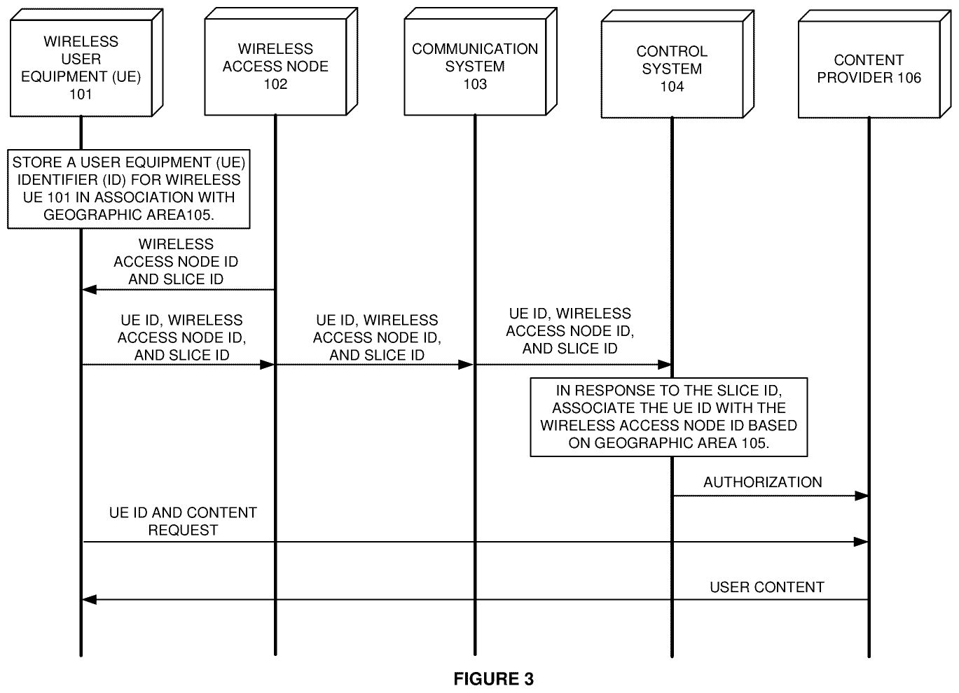

FIG. 3 illustrates an exemplary operation of data communication system 100 to authorize wireless UE 101 for the content service. The operation may differ in other examples. Communication system 103 stores a User Equipment (UE) Identifier (ID) for wireless UE 101 in association with geographic area 105 for wireless UE 101. In the geographic area 105, wireless access node 102 wirelessly transfers its wireless access node ID and a slice ID to wireless UE 101. The slice ID indicates the need to associate the UE ID with the wireless access node ID based on geographic area 105 and transfer an authorization to content provider 106. Thus, control system 104 is configured to interpret the slice ID as an instruction to associate the UE ID with the wireless access node ID based on geographic area 105 and transfer an authorization for UE 101 to content provider 106. Wireless UE 101 transfers the UE ID, the wireless access node ID, and the slice ID to control system 104 over wireless access node 102 and communication system 103. Control system 104 receives the UE ID, the wireless access node ID, and the slice ID transferred by wireless UE 101. In response to the slice ID, control system 104 authorizes wireless UE 101 for a content service by associating the UE ID with the wireless access node ID based on geographic area 105. For example, control system 105 may associate the UE ID with geographic area 105 based on storing the UE ID in association with geographic area 105. Control system 104 may then correlate geographic area 105 with the wireless access node ID based on a data structure that indicates that wireless access node 102 is located in geographic area 105. Control system 104 transfers a content authorization for UE 101 to content provider 106. Control system 104 also transfers the content authorization to UE 101 over communication system 103 and wireless access node 102. UE 101 then transfers its UE ID and a content request to content provider 106. In response to the authorization and the content request, content provider 106 delivers the content service wireless UE 101 in response to the authorization.

In alternative examples, UE 101 may transfer the request, UE ID, wireless access node ID, and slice ID to content provider 106 (instead of control system 104), Content provider 106 transfers this data to control system 104. In alternative examples, UE 101 and content provider 106 may exchange the request and the content over wireless access node 102 and communication system 103.

Advantageously, data communication system 100 efficiently and effectively authorizes users for content provider 106. Moreover, data communication system 100 restricts the improper sharing of usernames and passwords by using geographic service boundaries for authorization.

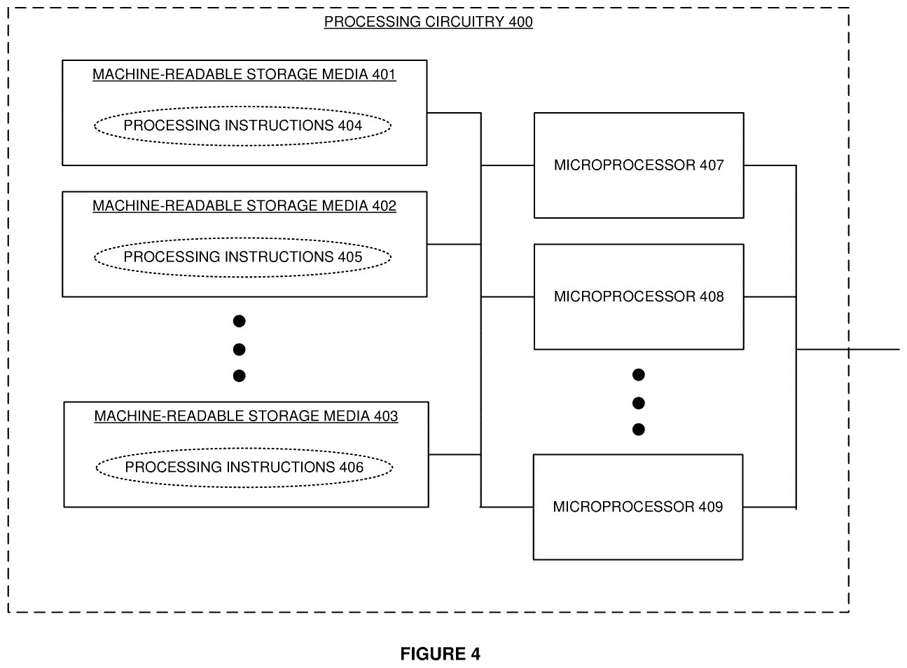

FIG. 4 illustrates exemplary processing circuitry 400 to authorize a wireless UE for a content service. Processing circuitry 400 comprises an example of wireless communication device 101, wireless access node 102, communication system 103, and control system 104, although device 101, node 102, system 103, and/or system 104 may differ. Processing circuitry 400 comprises machine-readable storage media 401-403 and microprocessors 407-409 that are communicatively coupled. Machine-readable storage media 401-403 store processing instructions 404-406 in a non-transitory manner. Microprocessors 407-409 comprise DSPs, CPUs, GPUs, ASICs, and/or some other data processing hardware. Machine-readable storage media 401-403 comprises RAM, flash circuitry, disk drives, and/or some other type of data storage apparatus. Microprocessors 407-409 retrieve processing instructions 404-406 from non-transitory machine-readable storage media 401-403. Microprocessors 407-409 execute processing instructions 404-406 to authorize a wireless UE for a content service as described above for data communication system 100 and as described below for wireless communication network 500. The amount of storage media, microprocessors, processing instructions that are shown in FIG. 4 may vary in other examples.

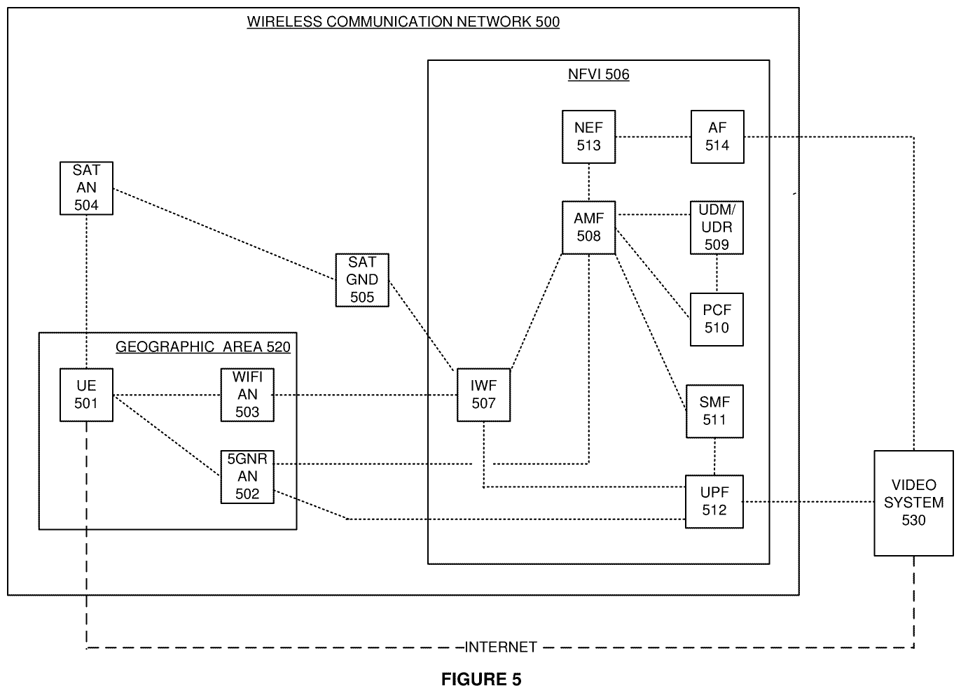

FIG. 5 illustrates exemplary wireless communication network 500 that authorizes wireless UE 501 for a video service. Wireless communication network 500 comprises an example of data communication system 100 and processing circuitry 400, although system 100 and circuitry 400 may differ. Wireless communication system 500 comprises User Equipment (UE) 501, Fifth Generation New Radio (5GNR) Access Node (AN) 502, Wireless Fidelity (WIFI) AN 503, Satellite Access Node (SAT AN) 504, satellite ground station (SAT GND) 505, and Network Function Virtualization Infrastructure (NFVI) 506. NFVI 506 comprises Interworking Function (IWF) 507, Access and Mobility Management Function (AMF) 508, Unified Data Management/Unified Data Repository (UDM/UDR) 509, Policy Control Function (PCF) 510, Session Management Function (SMF) 511, User Plane Function (UPF) 512, Network Exposure Function (NEF 513), and Application Function (AF) 514. In this example, geographic area 520 includes 5GNR AN 502 and WIFI AN 503, and satellite 504 serves geographic area 520 at the time.

In a first example, UE 501 uses 5GNR AN 502 for authorization. UE 501 and video system 530 communicate over the internet but not over wireless communication network 500. UE 501 wirelessly receives a cell ID for 5GNR AN 502 and a slice ID for a video slice from 5GNR AN 502. UE 501 transfers its International Mobile Subscriber Identifier (IMSI), the cell ID, and the slice ID to video system 530 over the internet. To authorize UE 501, video system 530 transfers the IMSI, cell ID, and slice ID to SMF 511 over AF 514 and NEF 513. In response to the slice ID, SMF 511 transfers the IMSI, cell ID, and slice ID to PCF 510 which forms part of the video slice. In response to the slice ID, PCF 501 uses the IMSI to retrieve subscriber information for UE 501 from UDM/UDR 509. The subscriber information for UE 501 includes a list of 5GNR ANs in geographic area 520. PCF 510 finds the cell ID from UE 501 in the list of 5GNR ANs in geographic area 520, and in response, transfers a video authorization for the IMSI to SMF 511. SMF 511 transfers the video authorization to video system 530 over NEF 513 and AF 514. In response to the video request and authorization, video system 530 streams the requested video to UE 501 over the internet. In an alternative to the first example, a Dynamic Network Name (DNN) or an Access Point Name (APN) could be used to direct the video authorization in a similar manner to the slice ID. For example, the DNN could trigger the SMF and PCF operations in the first example. In addition, UE 501 may use WIFI AN 503 to access the internet.

In a second example, UE 501 uses WIFI AN 503 for authorization. UE 501 and video system 530 communicate over the internet but not over wireless communication network 500. UE 501 wirelessly receives a Service Set ID (SSID) from WIFI AN 503—and use of the SSID is restricted to geographic area 520. UE 501 transfers its IMSI and SSID to video system 530 over the internet. To authorize UE 501, video system 530 transfers an authorization request, IMSI, and SSID to SMF 511 over AF 514 and NEF 513. In response to the authorization request for UE 501 from video system 530, SMF 511 uses the IMSI to retrieve a Dynamic Network Name (DNN) or Access Point Name (APN) for video authorization from UDM/UDR 509. In response to the DNN or APN, SMF 511 transfers the IMSI and SSID to PCF 510. In response to the DNN or APN, PCF 501 uses the IMSI to retrieve subscriber information for UE 501 from UDM/UDR 509. The subscriber information for UE 501 includes a list of SSIDs in geographic area 520. PCF 510 finds the SSID for WIFI AN 503 from UE 501 in the list of SSIDs in geographic area 520, and in response, transfers a video authorization for the IMSI to SMF 511. SMF 511 transfers the video authorization to video system 530 over NEF 513 and AF 514. In response to the video request and authorization, video system 530 streams the requested video to UE 501 over the internet. In an alternative to the second example, a slice ID could be used to direct the video authorization in a similar manner to the DNN or APN. For example, the slice ID could trigger the SMF and PCF operations in the second example. In addition, UE 501 may use WIFI AN 503 to access the internet.

In a third example, UE 501 uses satellite AN 504 for authorization. UE 501 and video system 530 communicate over the internet, but not wireless communication network 500. UE 501 wirelessly receives a satellite ID and a slice ID from satellite AN 504 when satellite AN 504 is serving geographic area 520. UE 501 typically detects other satellite IDs for other satellite ANs that currently serve geographic area 520. UE 501 transfers its IMSI, the satellite IDs, and slice ID to video system 530 over the internet. To authorize UE 501, video system 530 transfers the IMSI, satellite IDs, and slice ID to SMF 511 over AF 514 and NEF 513. In response to the slice ID, SMF 511 transfers the IMSI, satellite IDs, and slice ID to PCF 510 which forms part of the video slice. In response to the slice ID, PCF 501 uses the IMSI to retrieve subscriber information for UE 501 from UDM/UDR 509. The subscriber information for UE 501 includes a list of satellite IDs for satellite ANs that currently serve geographic area 520. PCF 510 finds the satellite IDs for satellite AN 504 and the other satellite ANs from UE 501 in the list of satellite IDs for satellite ANs that currently serve geographic area 520. In response, PCF 510 transfers a video authorization for the IMSI to SMF 511. SMF 511 transfers the video authorization for the IMSI to video system 530 over NEF 513 and AF 514. In response to the video request and authorization, video system 530 streams the requested video to UE 501 over the internet. In an alternative to the third example, a DNN or APN could be used to direct the video authorization in a similar manner to the slice ID. For example, the APN could trigger the SMF and PCF operations in the third example. In addition, UE 501 may use WIFI AN 503 to access the internet.

In a fourth example, UE 501 uses 5GNR AN 502. UE 501 and video system 530 communicate over wireless communication network 500. UE 501 wirelessly receives a slice ID for a video slice and a cell ID for 5GNR AN 502 from 5GNR AN 502. UE 501 transfers its IMSI, cell ID, and slice ID to AMF 508 over 5GNR AN 502. AMF 508 verifies that UE 501 is authorized for the video slice by retrieving subscriber information from UDM/UDR 509 that associates UE 501 and the slice ID. In response to the slice ID, AMF 508 and SMF 511 interact to develop context for a video link between UE 501 and video system 530. To perform protocol data unit policy establishment in response to the slice ID, SMF 511 transfers the IMSI and cell ID to PCF 510. To perform protocol data unit policy establishment in response to the slice ID, PCF 510 uses the IMSI to retrieve the subscriber information from UDM/UDR 509 that indicates a list of 5GNR ANs that are located in geographic area 520. PCF 510 finds the cell ID from UE 501 on the list of 5GNR ANs in geographic area 520, and in response, transfers a video authorization for the IMSI to SMF 511 which forwards the video authorization to AMF 508. SMF 511 transfers the context to UPF 512 which forms part of the video slice. AMF 508 transfers the context to 5GNR AN 502. AMF 508 transfers the context to UE 501 over 5GNR AN 502. SMF 511 transfers the video authorization and context to video system 530 over NEF 513 and AF 514. UE 501 transfers a video request to video system 530 over 5GNR AN 502 and UPF 512. In response to the video authorization and request, video system 530 streams the requested video to UE 501 over UPF 512 and 5GNR 502. In an alternative to the fourth example, a DNN or APN could be used to direct the video authorization in a similar manner to the slice ID. For example, the APN could trigger the SMF and PCF operations in the fourth example.

In a fifth example, UE 501 uses WIFI AN 503. UE 501 and video system 530 communicate over wireless communication network 500. UE 501 wirelessly receives an SSID for WIFI AN 502 from WIFI AN 502. The SSID is restricted to use in geographic area 520. UE 501 transfers its IMSI, SSID, and a video service request to AMF 508 over WIFI AN 503 and IWF 507. Based on the video service request, AMF 508 uses the IMSI to retrieve a DNN or APN for video authorization and delivery from UDM/UDR 509. In response to the DNN or APN, AMF 508 interacts with SMF 511 to develop context for a video link between UE 501 and video system 530 over WIFI AN 503, IWF 507, and UPF 512. To perform protocol data unit policy establishment in response to the DNN or APN, SMF 511 transfers the IMSI, SSID, and DNN or APN to PCF 510. To perform protocol data unit policy establishment in response to the DNN or APN, PCF 501 uses the IMSI to retrieve data from UDM/UDR 509 that indicates a list of SSIDs for WIFI ANs that are located in geographic area 520. PCF 510 finds the SSID for WIFI AN 503 from UE 501 on the list, and in response, transfers a video authorization for the IMSI to SMF 511 which forwards the video authorization to AMF 508. SMF 511 transfers the context to UPF 511. AMF 508 transfers the context to IWF 507. AMF 508 transfers the context to UE 501 over IWF 507 and WIFI AN 503. SMF 511 transfers the video authorization and the context to video system 530 over NEF 513 and AF 514. UE 501 transfers its IMSI and a video request to video system 530 over WIFI AN 503, IWF 507, and UPF 512. In response to the video authorization and request, video system 530 streams the requested video to UE 501 over UPF 512, IWF 507, and WIFI AN 503. In an alternative to the fifth example, a slice ID could be used to direct the video authorization in a similar manner to the DNN or APN. For example, the slice ID could trigger the SMF and PCF operations in the fifth example.

In a sixth example, UE 501 uses satellite AN 504. UE 501 and video system 530 communicate over wireless communication network 500. UE 501 wirelessly receives a satellite ID for satellite AN 504 and a slice ID for the video slice from satellite AN 504 which currently serves geographic area 520. UE 501 also detects other satellite IDs from other satellite ANs that currently serve geographic area 520. UE 501 transfers a its IMSI, satellite IDs, and slice ID to AMF 508 over satellite AN 504 and satellite ground station 505. AMF 508 verifies that UE 501 is authorized for the video slice by retrieving data that associates UE 501 and the slice ID from UDM/UDR 509. In response to the slice ID, AMF 508 interacts with SMF 511 to develop context for a video link between UE 501 and video system 530. To perform protocol data unit policy establishment in response to the slice ID, SMF 511 transfers the IMSI and satellite IDs to PCF 510 which forms part of the video slice. To perform protocol data unit policy establishment in response to the slice ID, PCF 510 uses the IMSI to retrieve subscriber data from UDM/UDR 509 that indicates the satellite IDs for satellite ANs that currently serve geographic area 520. PCF 510 then finds the satellite IDs from UE 501 in the list of satellite IDs for satellite ANs that currently serve geographic area 520, and in response, transfers a video authorization for the IMSI to SMF 511 which forwards the video authorization to AMG 508. SMF 511 transfers the context to UPF 512 which forms part of the video slice. AMF 508 transfers the context to IWF 507, satellite ground station 505, and satellite AN 504. AMF 508 transfers the context to UE 501 over IWF 507, satellite ground station 505, and satellite AN 504. SMF 511 transfers the video authorization and context for the video link to video system 530 over NEF 513 and AF 514. UE 501 transfers a video request to video system 530 over satellite AN 504, satellite ground station 505, IWF 507, and UPF 512. In response to the video authorization and request, video system 530 streams the requested video to UE 501 over UPF 512, IWF 507, satellite ground station 505, and satellite AN 504. In an alternative to the fourth example, a DNN or APN could be used to direct the video authorization in the same manner as the slice ID. For example, the DNN could trigger the SMF and PCF operations in the sixth example.

If the authorization fails in the above examples, SMF 511 may verify that the IMSI is on a list of authorized IMSIs that are not geographically restricted to authorize UE 501 for the video service.

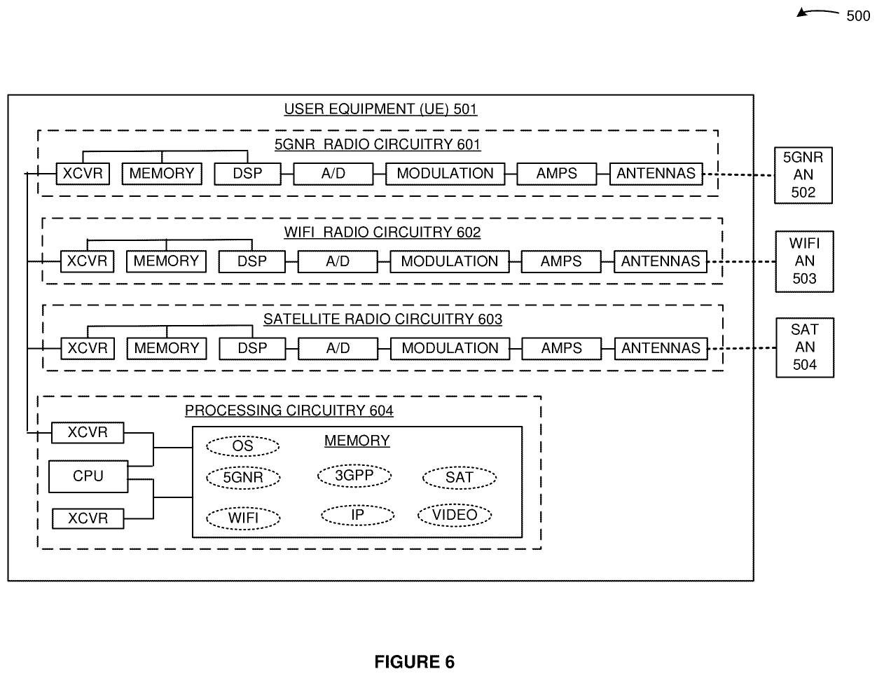

FIG. 6 illustrates exemplary UE 501 in the wireless communication network 500 that authorizes wireless UE 501 for the video service. UE 501 comprises an example of wireless UE 101 and processing circuitry 400, although UE 101 and circuitry 400 may differ. UE 501 comprises Fifth Generation New Radio (5GNR) radio circuitry 601, Wireless Fidelity (WIFI) radio circuitry 602, satellite radio circuitry 603, and processing circuitry 604. Radio circuitry 601-603 comprises antennas, amplifiers, filters, modulation, analog-to-digital interfaces, DSPs, memories, and transceivers (XCVRs) that are coupled over bus circuitry. Processing circuitry 604 comprises one or more CPUs, one or more memories, and one or more transceivers that are coupled over bus circuitry. The one or more memories in processing circuitry 604 store software like an Operating System (OS), 5GNR Application (5GNR), 3GPP Application (3GPP), WIFI Application (WIFI), Satellite Application (SAT), Internet Protocol application (IP), and Video application (VIDEO). The antennas in radio circuitry 601-603 exchange wireless signals with ANs 502-505. Transceivers in radio circuitry 601-603 are coupled to transceivers in processing circuitry 604. In processing circuitry 604, the one or more CPUs retrieve the software from the one or more memories and execute the software to direct the operation of UE 501 as described herein.

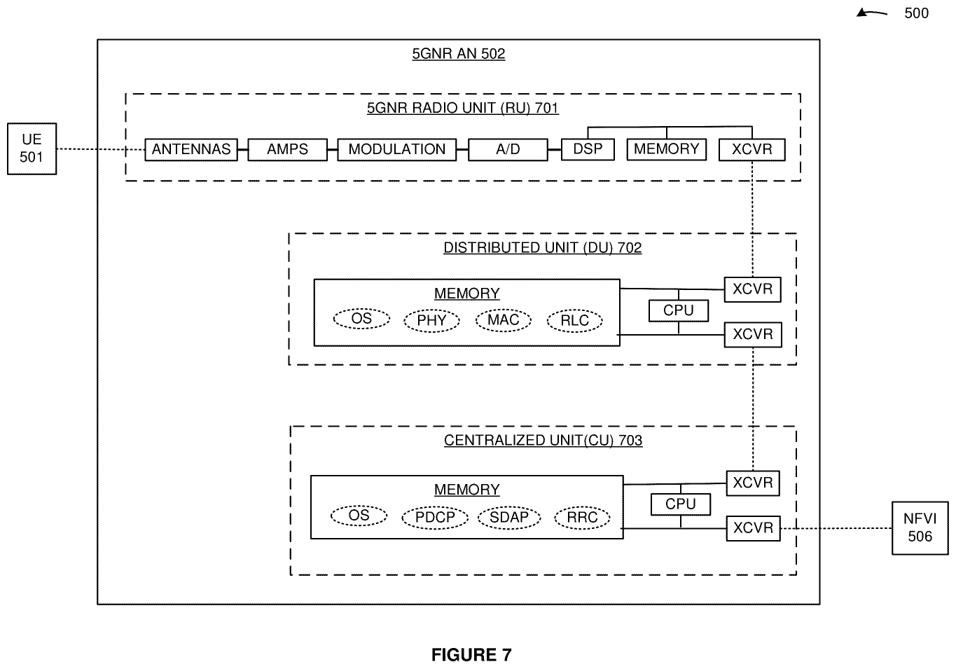

FIG. 7 illustrates exemplary Fifth Generation New Radio (5GNR) access node 502 in wireless communication network 500 that that authorizes wireless UE 501 for the video service. 5GNR AN 502 comprises an example of wireless access node 102 and processing circuitry 400, although node 102 and circuitry 400 may differ. 5GNR AN 502 comprises 5GNR Radio Unit (RU) 701, Distributed Unit (DU) 702, and Centralized Unit (CU) 703. 5GNR RU 701 comprises antennas, amplifiers, filters, modulation, analog-to-digital interfaces, DSP, memory, radio applications, and transceivers that are coupled over bus circuitry. DU 702 comprises memory, CPU, user interfaces and components, and transceivers that are coupled over bus circuitry. The memory in DU 702 stores operating system and 5GNR network applications for Physical Layer (PHY), Media Access Control (MAC), and Radio Link Control (RLC). CU 703 comprises memory, CPU, and transceivers that are coupled over bus circuitry. The memory in CU 703 stores an operating system and 5GNR network applications for Packet Data Convergence Protocol (PDCP), Service Data Adaption Protocol (SDAP), and Radio Resource Control (RRC). The antennas in 5GNR RU 701 are wirelessly coupled to UE 501 over 5GNR links. Transceivers in 5GNR RU 701 are coupled to transceivers in DU 702. Transceivers in DU 702 are coupled to transceivers in CU 703. Transceivers in CU 703 are coupled to transceivers in NFVI 506. The DSP and CPU in RU 701, DU 702, and CU 703 execute the radio applications, operating systems, and network applications to exchange data and signaling between UE 501 and NFVI 506 as described herein. In particular, 5GNR RU 701 wirelessly broadcasts its cell ID in geographic area 520.

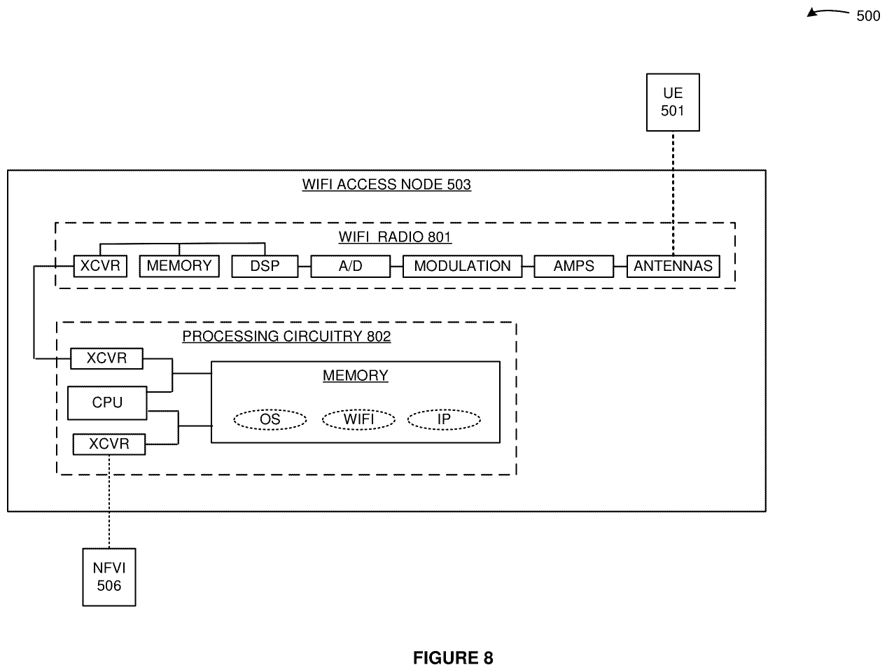

FIG. 8 illustrates exemplary Wireless Fidelity (WIFI) access node 503 in wireless communication network 500 that authorizes wireless UE 501 for the content service. WIFI AN 504 comprises an example of wireless access node 102 and processing circuitry 400, although node 102 and circuitry 400 may differ. WIFI AN 503 comprises WIFI radio 801 and processing circuitry 802. Radio 801 comprises antennas, amplifiers, filters, modulation, analog-to-digital interfaces, DSPs, memories, and transceivers that are coupled over bus circuitry. Processing circuitry 802 comprises one or more CPUs, one or more memories, and one or more transceivers that are coupled over bus circuitry. The one or more memories in processing circuitry 802 store software like an Operating System (OS), WIFI application (WIFI), and IP application (IP). The antennas in WIFI radio 801 exchange WIFI signals with UE 501. Transceivers in radio 801 are coupled to transceivers in processing circuitry 802. Transceivers in processing circuitry 802 are coupled to transceivers in NFVI 506. In processing circuitry 802, the one or more CPUs retrieve the software from the one or more memories and execute the software to exchange data and signaling between UE 501 and NFVI 506 as described herein. In particular, WIFI radio 801 wirelessly broadcasts its SSID in geographic area 520.

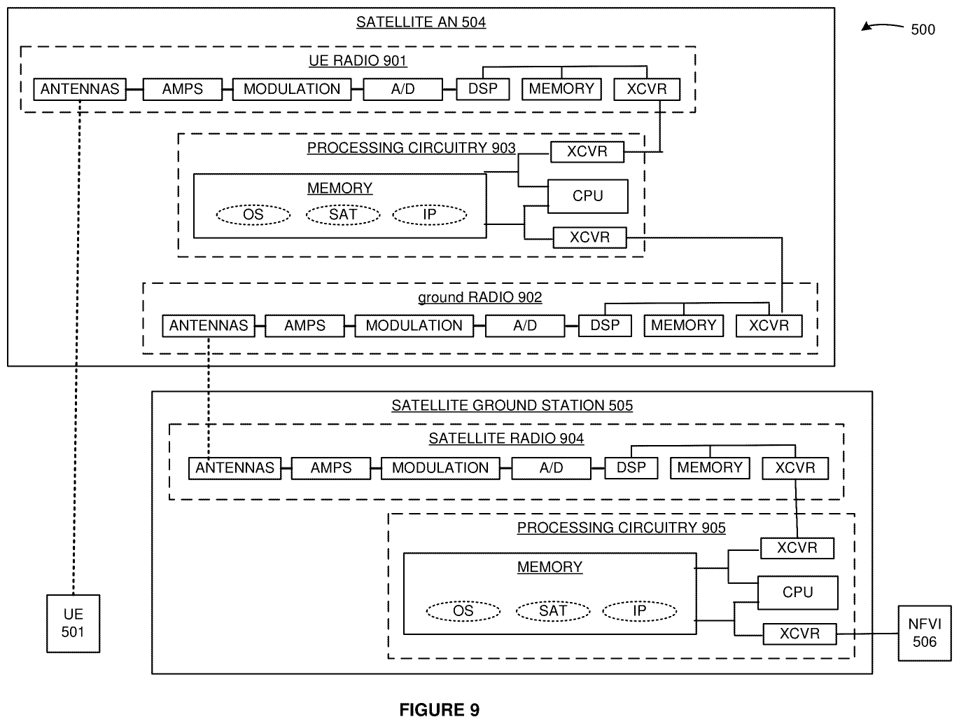

FIG. 9 illustrates exemplary satellite access node 504 and ground station 505 in wireless communication network 500 that authorizes wireless UE 501 for the video service. Satellite AN 504 comprises an example of wireless access node 102, and satellite ground station 505 comprises an example of communication system 103, although node 102, system 103, and circuitry 400 may differ. Satellite AN 504 comprises UE radio 901, ground radio 902 and processing circuitry 903. Satellite ground station 505 comprises satellite radio 904 and processing circuitry 905. Radios 901-902 and 904 comprise antennas, amplifiers, filters, modulation, analog-to-digital interfaces, DSPs, memories, and transceivers that are coupled over bus circuitry. Processing circuitry 903 and 905 comprise one or more CPUs, one or more memories, and one or more transceivers that are coupled over bus circuitry. The one or more memories in processing circuitry 903 and 905 store software like an Operating System (OS), Satellite Application (SAT), and IP Application (IP). The antennas in UE radio 901 exchange satellite signals with UE 501. Transceivers in UE radio 901 are coupled to transceivers in processing circuitry 903. Transceivers in processing circuitry 903 are coupled to transceivers in ground radio 902. The antennas in ground radio 902 exchange satellite signals with antennas in satellite radio 904, and the antennas in satellite radio 904 exchange the satellite signals with ground radio 902. Transceivers in satellite radio 904 are coupled to transceivers in processing circuitry 905. Transceivers in processing circuitry 905 are coupled to transceivers in NFVI 506. In processing circuitry 903 and 905, the one or more CPUs retrieve the software from the one or more memories and execute the software to exchange data and signaling between UE 501 and NFVI 506 as described herein. In particular, UE radio 901 wirelessly broadcasts its satellite ID to geographic area 520.

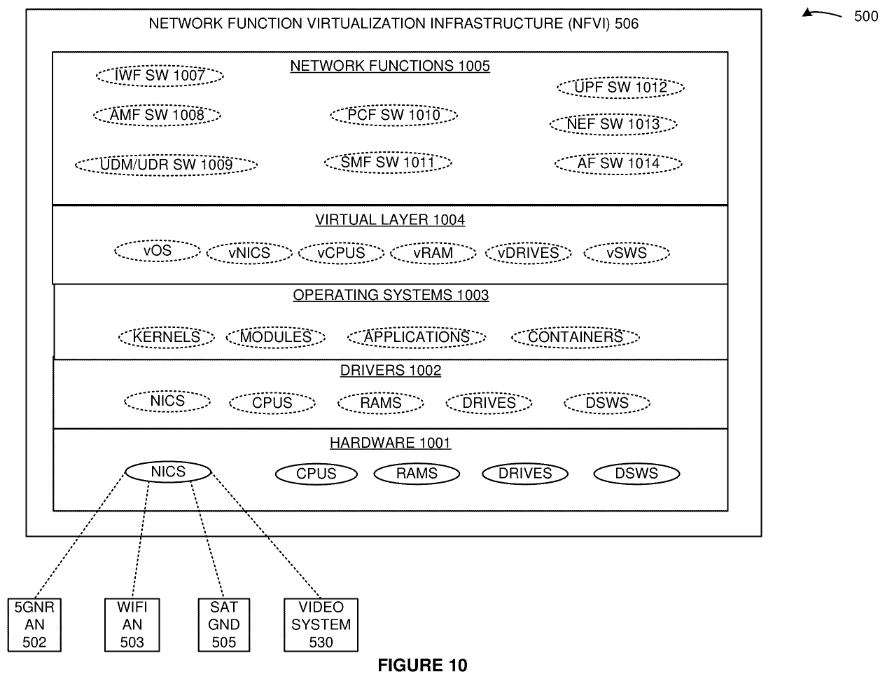

FIG. 10 illustrates exemplary Network Function Virtualization Infrastructure (NFVI) 506 in wireless communication network 500 that authorizes wireless UE 501 for the video service. NFVI 506 comprises an example of communication system 103, control system 104, and processing circuitry 400, although systems 103-104 and circuitry 400 may differ. NFVI 506 comprises hardware 1001, hardware drivers 1002, operating systems 1003, virtual layer 1004, and network functions 1005. Hardware 1001 comprises Network Interface Cards (NICS), CPUS, RAM, Flash/Disk Drives (DRIVES), and Data Switches (DSWS). Hardware drivers 1002 comprise software that is resident in the NICS, CPUS, RAM, DRIVES, and DSWS. Operating systems 1003 comprise kernels, modules, applications, and containers. Virtual layer 1004 comprises virtual Operating Systems (vOS), vNICS, vCPUS, vRAM, vDRIVES, and vSWS. Network Functions 1005 comprises IWF SW 1007, AMF SW 1008, and UDM/UDR SW 1009. PCF SW 1010, SMF SW 1011, UPF SW 1012, NEF SW 1013, and AF SW 1014. The NICS in hardware 1001 are coupled to ANs 502-504, satellite ground station 505, and video system 530. Hardware 1001 executes hardware drivers 1002, operating systems 1003, virtual layer 1004, and network functions 1005 to form and operate IWF 507, AMF 508, UDM/UDR 509, PCF 510, SMF 511, UPF 512, NEF 513, and AF 514 as described herein. NFVI 506 comprises one or more microprocessors and one or more non-transitory machine-readable storage media that store processing instructions that direct NFVI 506 to exchange data and signaling between ANs 502-504, satellite ground station 505, and video system 530 as described herein. In particular, NFVI 506 authorizes UE 501 for video service based on the INSI, AN ID, and geographic area 520. NFVI 506 may be located at a single site or be distributed across multiple geographic areas.

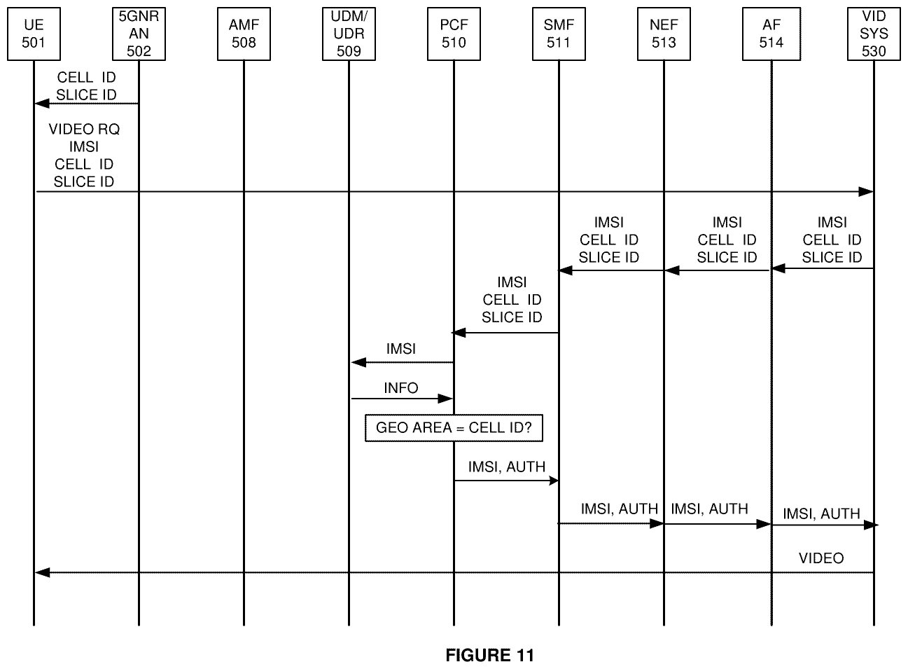

FIG. 11 illustrates an exemplary operation of wireless communication network 500 that authorizes wireless UE 501 for the video service. The operation may differ in other examples. UE 501 wirelessly receives a cell ID for 5GNR AN 502 and a slice ID for the video slice from 5GNR AN 502. UE 501 transfers a video request, its IMSI, the cell ID, and the slice ID to video system 530. To authorize UE 501 for the video service, video system 530 transfers the IMSI, cell ID, and slice ID to SMF 511 over AF 514 and NEF 513. In response to the slice ID, SMF 511 transfers the IMSI, cell ID, and slice ID to PCF 510 which forms part of the video slice. In response to the slice ID, PCF 501 uses the IMSI to retrieve subscriber information for UE 501 from UDM/UDR 509. The subscriber information for UE 501 includes a list of 5GNR ANs in geographic area 520. PCF 510 finds the cell ID for 5GNR AN 502 from UE 501 in the list of 5GNR ANs in geographic area 520, and in response, transfers a video authorization for the IMSI to SMF 511. SMF 511 transfers the video authorization for the IMSI to video system 530 over NEF 513 and AF 514. In response to the video request and authorization, video system 530 streams the requested video to UE 501. In an alternative operation, a DNN or APN could be used to direct the video authorization in a similar manner to the slice ID. In another alternative operation, IWF 507 and WIFI AN 503 or satellite AN 504/ground station 505 could be used in a similar manner to 5GNR AN 502.

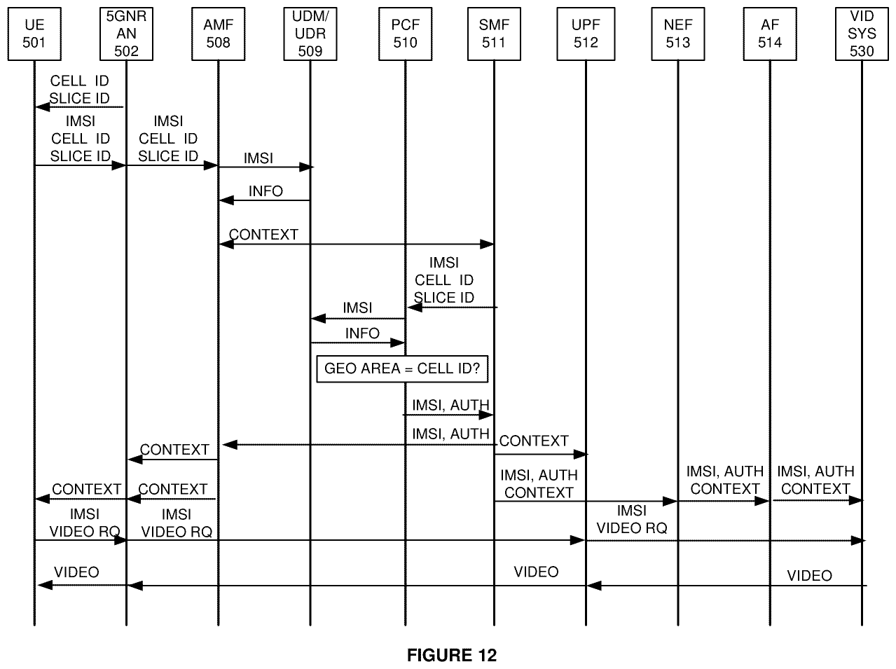

FIG. 12 illustrates an exemplary operation of wireless communication network 500 that authorizes wireless UE 501 for the video service. The operation may differ in other examples. UE 501 wirelessly receives a slice ID for the video slice and a cell ID for 5GNR AN 502 from 5GNR AN 502. UE 501 transfers its IMSI, cell ID, and slice ID to AMF 508 over 5GNR AN 502. AMF 508 verifies that UE 501 is authorized for the video slice by retrieving subscriber information from UDM/UDR 509 that associates UE 501 and the slice ID. In response to the slice ID, AMF 508 interacts with SMF 511 to generate context for a video link between UE 501 and video system 530 over 5GNR AN 502 and UPF 512. To perform protocol data unit policy establishment and in response to the slice ID, SMF 511 transfers the IMSI, cell ID, and slice ID to PCF 510. To perform protocol data unit policy establishment in response to the slice ID, PCF 510 uses the IMSI to retrieve subscriber information from UDM/UDR 509 that indicates a list of 5GNR ANs that are located in geographic area 520. PCF 510 finds the cell ID for 5GNR AN 502 from UE 501 on the list of 5GNR ANs in geographic area 520, and in response, transfers a video authorization for the IMSI to SMF 511 which forwards the video authorization to AMF 508. SMF 511 transfers the context to UPF 512. AMF 508 transfers the context to 5GNR AN 502. AMF 508 also transfers the context to UE 501 over 5GNR AN 502. SMF 511 transfers the IMSI, video authorization, and context to video system 530 over NEF 513 and AF 514. UE 501 transfers a video request to video system 530 over the video link that traverses 5GNR AN 502 and UPF 512. In response to the video authorization and request, video system 530 streams the requested video to UE 501 over the video link that traverses UPF 512 and 5GNR 502. In an alternative operation, a DNN or APN could be used to direct the video authorization in a similar manner to the slice ID. In another alternative operation, IWF 507 and WIFI AN 503 or satellite AN 504/ground station 505 could be used in a similar manner to 5GNR AN 502.

Advantageously, wireless communication network 500 efficiently and effectively authorizes users for content provider 106. Moreover, wireless communication network 500 restricts the improper sharing of usernames and passwords by using geographic service boundaries for authorization.

The wireless communication system circuitry described above comprises computer hardware and software that form special-purpose data communication circuitry to authorize a wireless UE for a content service. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose data communication circuitry system to authorize the wireless UE for the content service.

The above description and associated figures teach the best mode of the invention.

The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A method comprising:
storing a User Equipment (UE) Identifier (ID) for a wireless UE in association with a geographic area for the wireless UE;
wirelessly transferring a wireless access node ID to the wireless UE from a wireless access node in the geographic area;
receiving the UE ID and the wireless access node ID transferred by the wireless UE; and
authorizing the wireless UE for a content service by associating the UE ID with the wireless access node ID based on the geographic area, wherein the content service is delivered to the wireless UE in response to the authorization.

2. The method of claim 1 wherein the geographic area comprises a zip code.

3. The method of claim 1 wherein the geographic area comprises at least one of a network cell and network sector.

4. The method of claim 1 wherein the geographic area comprises a physical address.

5. The method of claim 1 wherein the wireless access node ID comprises a Fifth Generation New Radio (5GNR) NodeB ID.

6. The method of claim 1 wherein the wireless access node ID comprises a satellite ID.

7. The method of claim 1 wherein the wireless access node ID comprises a wireless fidelity service set ID.

8. The method of claim 1 further comprising:
storing the UE ID in association with a slice ID; and wherein
authorizing the wireless UE for the content service by associating the UE ID with the wireless access node ID based on the geographic area comprises associating the UE ID with the wireless access node ID based on the geographic area in response to the slice ID.

9. The method of claim 1 further comprising:
storing the UE ID in association with a Dynamic Network Name (DNN); and wherein
authorizing the wireless UE for the content service by associating the UE ID with the wireless access node ID based on the geographic area comprises associating the UE ID with the wireless access node ID based on the geographic area in response to the DNN.

10. The method of claim 1 further comprising:
storing the UE ID in association with a Access Point Name (APN); and wherein
authorizing the wireless UE for the content service by associating the UE ID with the wireless access node ID based on the geographic area comprises associating the UE ID with the wireless access node ID based on the geographic area in response to the APN.

11. The method of claim 1 wherein receiving the UE ID and the wireless access node ID transferred by the wireless UE comprises receiving the UE ID and the wireless access node ID from a content provider that and that delivers the content service and that received the UE ID and the wireless access node ID from the wireless UE.

12. One or more non-transitory computer readable storage media having program instructions stored thereon, wherein the program instructions, when executed by a computing system, direct the computing system to perform operations, the operations comprising:
storing an International Mobile Subscriber Identifier (IMSI) for a user in association with a cell coverage area for the user;
receiving the IMSI and a cell Identifier (ID) from the user wherein a wireless access node in the cell coverage area wirelessly transfers the cell ID;
authorizing the user for a content service by correlating the IMSI with the cell ID based on the cell coverage area for the user; and
transferring an authorization for the content service for the user, wherein the content service is delivered to the UE in response to receiving the authorization.

13. A data communication system comprising:
a control system to store a User Equipment (UE) Identifier (ID) for a wireless UE in association with a geographic area for the wireless UE;
a wireless access node in the geographic area to wirelessly transfer a wireless access node ID to the wireless UE;
the control system to receive the UE ID and the wireless access node ID transferred by the wireless UE; and
the control system to authorize the wireless UE for a content service by associating the UE ID with the wireless access node ID based on the geographic area, wherein the content service is delivered to the wireless UE in response to the authorization.

14. The data communication system of claim 13 wherein the geographic area comprises a zip code.

15. The data communication system of claim 13 wherein the geographic area comprises at least one of a network cell and network sector.

16. The data communication system of claim 13 wherein the geographic area comprises a physical address.

17. The data communication system of claim 13 wherein the wireless access node ID comprises one of a Fifth Generation New Radio (5GNR) NodeB ID, satellite ID, and wireless fidelity service set ID.

18. The data communication system of claim 13 further comprising:
the control system to store the UE ID in association with a slice ID; and wherein
the control system is to authorize the wireless UE for the content service by associating the UE ID with the wireless access node ID based on the geographic area in response to the slice ID.

19. The data communication system of claim 13 further comprising:
the control system to store the UE ID in association with a Dynamic Network Name (DNN); and wherein
the control system is to authorize the wireless UE for the content service by associating the UE ID with the wireless access node ID based on based on the geographic area in response to the DNN.

20. The data communication system of claim 13 further comprising:
the control system to store the UE ID in association with an Access Point Name (APN); and wherein
the control system is to authorize the wireless UE for the content service by associating the UE ID with the wireless access node ID based on the geographic area in response to the APN.
